(19) United States
(12) Patent Application Publication
(10) Pub. No.: US 2004/0150615 A1
(43) Pub. Date: Aug. 5, 2004

(54) Wire/wireless adapter for wired computer peripherals

(76) Inventor: Chia-Hsiang Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/355,011

(22) Filed: Jan. 31, 2003

(51) Int. Cl. G09G 5/00

(52) U.S. Cl. 345/156

(57) ABSTRACT

The present invention discloses a wire/wireless adapter for wired computer peripherals comprising an equipment side and a host side, wherein the equipment side comprises at least a first microprocessor, a first adapter port, an ID identification module, a first RF modulation circuit, a first RF demodulation circuit, a battery and a first antenna; the host side comprises a second microprocessor, a second adapter port, a second RF modulation circuit, a second RF demodulation circuit and a second antenna, the wire/wireless adapter in the present invention effectively transmitting a signal of the wired computer peripheral originally connected by transmission cable to the host side via wireless communication.

### BACKGROUND OF THE INVENTION

1. Field of the Invention

The present invention is related to a wire/wireless adapter for wired computer peripherals, and more particularly, to a wire/wireless adapter transmitting a signal of the original wired keyboard to the host side via wireless communication without modifying the original wired keyboard.

2. Description of the Prior Art

Traditional computer peripherals connecting to computer hosts by wire, so there is at least one connecting cable between every computer peripheral and the computer host. In this way, connecting cables limit the placements of the computer peripheral and the computer hosts. Additionally, with the number of computer peripherals increasing, there will be more connecting cables needed, making the connecting cables easy to tie up in knots disorderly and hard for user to clear up.

Therefore, some people have modified a small part of the computer peripherals such as keyboards and mice to have wireless transmission components equipped. Although it is more convenient for users, however, both the hosts and the computer peripherals have to be equipped with wireless transmission components, that is, keyboards and mice originally installed on host computers are no longer available, users have to pay extra cost to the upgrade of wireless peripherals and more time to adapt to new wireless peripherals.

Therefore, the tradition wired computer peripherals present several shortcomings needed to be solved.

In view of the above-described deficiency of traditional wired computer peripherals, after years of constant effort in research, the inventor of this invention has consequently developed and proposed a wire/wireless adapter for wired computer peripherals.

### SUMMARY OF THE INVENTION

It is an object of the present invention to provide a wire/wireless adapter for wired computer peripherals, wherein the wire/wireless adapter can effectively transmit the signal of the wired computer peripheral via wireless communication.

It is another object of the present invention to provide a wire/wireless adapter for wired computer peripherals, while user can upgrade the original wired computer peripheral to wireless-transmission-enabled device without modifying it, so the upgrade cost is greatly reduced.

It is still another object of the present invention to provide a wire/wireless adapter for wired computer peripherals to help users to adapt to new device easily without any problem.

The present invention provides a wire/wireless adapter for wired computer peripherals comprising an equipment side and a host side, wherein the equipment side comprises at least a microprocessor, an adapter port, an ID identification module, a RF modulation circuit, a first RF demodulation circuit, a battery and an antenna; the host side comprises a microprocessor, an adapter port, a RF modulation circuit, a RF demodulation circuit and an antenna. The wire/wireless adapter disclosed in the present invention effectively transmitting a signal of the wired computer peripheral, which is originally connected by transmission cable, to the host side via wireless communication.

### BRIEF DESCRIPTION OF THE DRAWINGS

The drawings disclose an illustrative embodiment of the present invention which serves to exemplify the various advantages and objects hereof, and are as follows:

FIG. 1 shows the block diagram of a wire/wireless adapter for wired computer peripherals;

FIG. 2 shows the block diagram of a wire/wireless adapter for wired computer peripherals in a USB application; and

FIG. 3 illustrates an exemplar embodiment of a wire/wireless adapter for wired computer peripherals.

### DETAILED DESCRIPTION OF THE PREFERRED EMBODIMENT

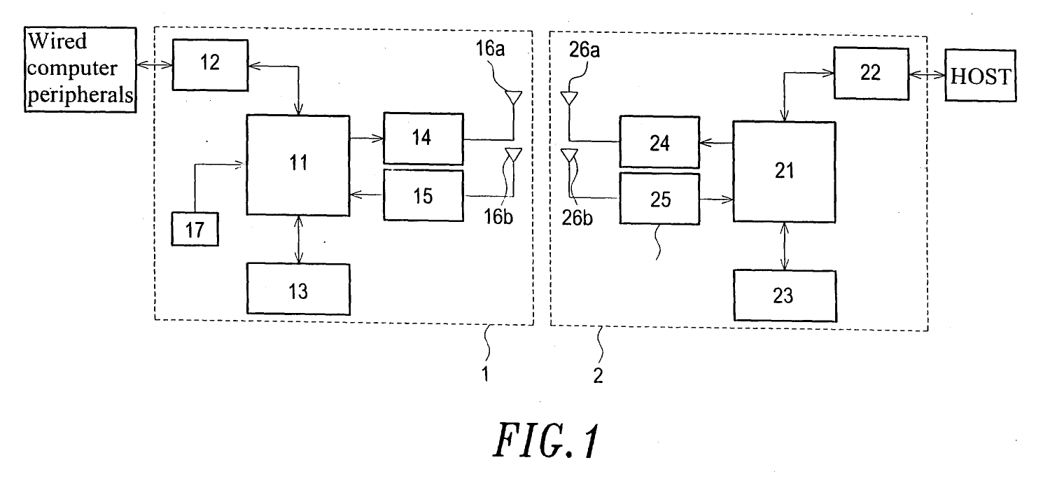

Please refer to FIG. 1, the present invention discloses a wire/wireless adapter for wired computer peripherals. The wire/wireless adapter mainly comprises an equipment side 1 and a host side 2; wherein the equipment side 1 comprises a microprocessor (the first microprocessor) 11, an adapter port (the first adapter port) 12, an ID identification module (the first ID identification module) 13, a RF modulation circuit (the first RF modulation circuit) 14, a RF demodulation circuit (the first RF demodulation circuit) 15, a transmitter antenna (the first transmitter antenna) 16a, a receiver antenna (the first receiver antenna) 16b and battery 17; the adapter port 12 can be a PS2 or USB transmission interface preferably connecting to wired computer peripherals; the host side 2 comprises microprocessor (the second microprocessor) 21, an adapter port (the second adapter port) 22, an ID identification module (the second ID identification module) 23, a RF modulation circuit (the second RF modulation circuit) 24, a RF demodulation circuit (the second RF demodulation circuit) 25, a transmitter antenna (the second transmitter antenna) 26a and a receiver antenna (the second receiver antenna) 26b; wherein the adapter port 22 can be a PS2 or a USB transmission interface preferably connecting to the host.

When the computer peripheral uses a PS2 port for transmission, the adapter port 12 sends the PS2 signal from the computer peripheral to microprocessor 11, and the ID identification module sends the ID identification signal to microprocessor 11 as well. The microprocessor 11 processes the PS2 signal and the ID identification signal and sends a signal to the RF modulation circuit 14, the RF modulation circuit 14 modulates the signal into a RF modulated signal and sends the RF modulated signal to the host side 2 via the transmitter antenna 16a; wherein the battery 17 on the equipment side 1 provides power to the microprocessor 11 to enable the other circuits on the equipment side 1.

When the receiver antenna 26b on the host side 2 receives the RF modulated signal from the equipment side 1, the RF demodulation circuit 25 demodulates the RF modulated signal into the signal and sends the signal to the microprocessor 21. The microprocessor 21 processes the signal and sends the ID identification signal to the ID identification module 23 for verification, and the PS2 signal is transmitted through the adapter port 22 to the host if the ID identification signal is verified.

When the host is to transmit a signal to the computer peripheral, the microprocessor 21 first receives the PS2 signal from the host and the ID identification signal from the ID identification module 23, then the microprocessor 21 processes the PS2 signal and the ID identification signal and sends the signal to the RF modulation circuit 24, the RF modulation circuit 24 modulates the signal into a RF modulated signal and sends the RF modulated signal to the equipment side 1 via the transmitter antenna 26a. When the receiver antenna 16b on the equipment side 1 receives the RF modulated signal, the RF demodulation circuit 15 demodulates the RF modulated signal into the signal and sends the signal to the microprocessor 11. The microprocessor 11 processes the signal and sends the ID identification signal to the ID identification module 13 for verification, and the PS2 signal is transmitted through the adapter port 12 to the computer peripheral if the ID identification signal is verified.

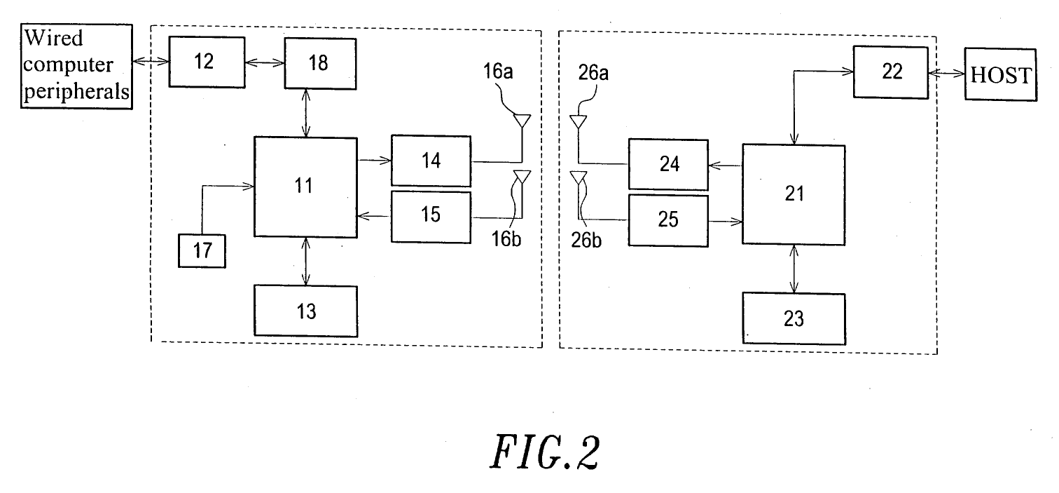

Please refer to FIG.2, when the computer peripheral uses a USB port as interface for transmission, then on the equipment side 1, a USB controller (the first USB controller) 18 is added between the adapter port 12 and the microprocessor 11. The USB controller 18 basically converts a USB signal into a decipherable signal for the microprocessor 11, or converts a signal from the microprocessor 11 into a USB signal.

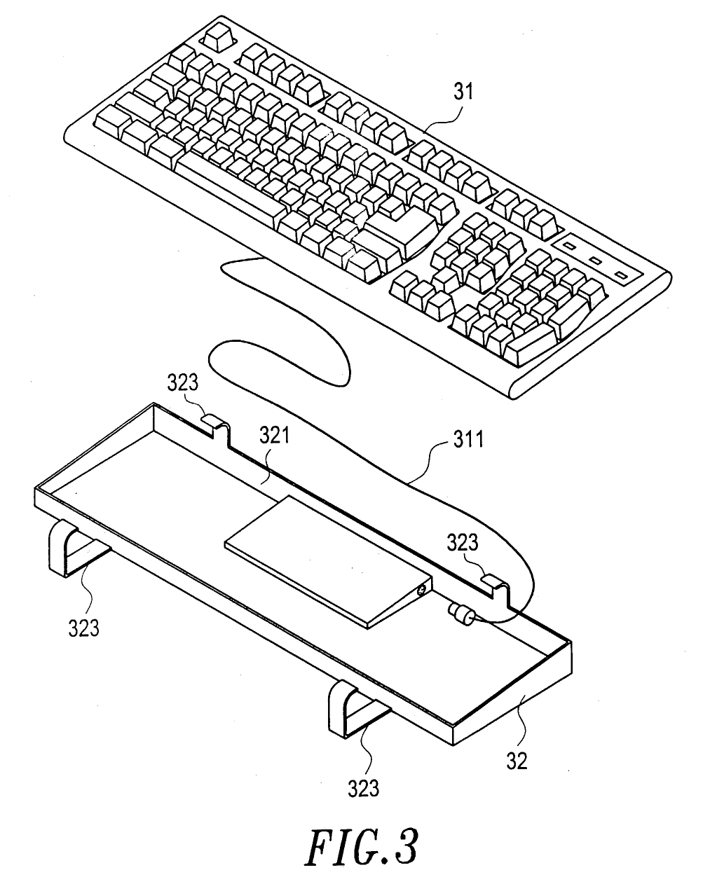

Please refer to FIG.3, in one preferred embodiment of the present invention, a base 32 is used for placing the keyboard 31. The base 32 comprises a wire/wireless adapter for wired computer peripherals disclosed in the present invention, a compartment 321 for placing the transmission cable 311 of the keyboard 31 and a buckle to fix the keyboard 31 onto the base 32.

The present invention provides a wire/wireless adapter for wired computer peripherals, compared to prior-art techniques, it is advantageous in:

1. The present invention provides a wire/wireless adapter for wired computer peripherals, wherein the wire/wireless adapter can effectively transmit the signal of the wired computer peripheral via wireless communication.

2. The present invention provides a wire/wireless adapter for wired computer peripherals, while user can upgrade the original wired computer peripheral to wireless-transmission-enabled device without modifying it, the upgrade cost is greatly reduced.

3. The present invention provides a wire/wireless adapter for wired computer peripherals to help users to adapt to new device easily without any problem.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A wire/wireless adapter for a wired computer peripheral comprising an equipment side and a host side, said equipment side comprising:
a first adapter port using a first PS2 transmission interface and connecting to said wired computer peripheral;
a first ID identification module comprising a password for purposes of setting up and password identification;
a first microprocessor connecting to said first adapter port and said first ID identification module to enable bi-directional transmission with said first adapter port and said first ID identification module respectively;
a battery for providing power to said first microprocessor;
a first RF modulation circuit for modulating said signal coming from said first microprocessor into a modulated signal and transmitting said modulated signal to said host side via a first transmitter antenna;
a first RF demodulation circuit for demodulating said modulated signal coming from said host side into said signal and transmitting said signal to said first microprocessor; and
said host side comprising:
a second adapter port using a second PS2 transmission interface to connect to said host;
a second ID identification module comprising a password for purposes of setting up and password identification;
a second microprocessor connecting to said second adapter port and said second ID identification module to enable bidirectional transmission with said second adapter port and said second ID identification module respectively;
a second RF modulation circuit for modulating said signal coming from said second microprocessor into said modulated signal and transmitting said modulated signal to said equipment side via a second transmitter antenna; and
a second RF demodulation circuit for demodulating said modulated signal coming from said equipment side into said signal and transmitting said signal to said second microprocessor.

2. A wire/wireless adapter for a wired computer peripheral comprising an equipment side and a host side, said equipment side comprising:
a first adapter port using a first USB transmission interface and connecting to said wired computer peripheral;
a first ID identification module comprising a password for purposes of setting up and password identification;
a first USB controller connecting to said first adapter port for signal conversion;
a first microprocessor connecting to said first USB controller and said first ID identification module to enable bidirectional transmission with said first USB controller and said first ID identification module respectively;
a battery for providing power to said first microprocessor;
a first RF modulation circuit for modulating a signal coming from said first microprocessor into a modulated signal and transmitting said modulated signal to said host side via a first transmitter antenna;
a first RF demodulation circuit for demodulating said modulated signal coming from said host side into said signal and transmitting said signal to said first microprocessor; and
said host side comprising:
a second adapter port using a second USB transmission interface to connect to said host;
a second ID identification module comprising a password for purposes of setting up and password identification;
a second microprocessor connecting to said second adapter port and said second ID identification module to enable bidirectional transmission with said second adapter port and said second ID identification module respectively;
a second RF modulation circuit for modulating said signal coming from said second microprocessor into said modulated signal and transmitting said modulated signal to said equipment side via a second transmitter antenna; and
a second RF demodulation circuit for demodulating said modulated signal coming from said equipment side into said signal and transmitting said signal to said second microprocessor.

3. The wire/wireless adapter for a wired computer peripheral as recited in claim 1, wherein said equipment side further comprises a base for placing a keyboard, said base comprising a compartment for placing a transmission cable of said keyboard and a buckle on said base to hold said keyboard.

4. The wire/wireless adapter for a wired computer peripheral as recited in claim 2, wherein said equipment side further comprises a base for placing a keyboard, said base comprising a compartment for placing a transmission cable of said keyboard and a buckle on said base to hold said keyboard.
